(19) United States
(12) Patent Application Publication
(10) Pub. No.: US 2022/0326020 A1
(43) Pub. Date: Oct. 13, 2022

(54) HOUSEHOLD APPLIANCES NAVIGATION SYSTEM

(71) Applicant: Haier US Appliance Solutions, Inc., Wilmington, DE (US)

(72) Inventors: Neki Jashwant Patel, Hyderabad (IN); Aparna Vajja, Hyderabad (IN); Michael Goodman Schroeder, Louisville, KY (US); Susheel Kumar Panda, Hyderabad (IN)

(21) Appl. No.: 17/225,166

(22) Filed: Apr. 8, 2021

(51) Int. Cl. G01C 21/20; A61G 5/04; H04W 4/33; H04W 4/38; H04W 4/024; H04W 4/80; G06F 3/16

(52) U.S. Cl. CPC G01C 21/206; A61G 5/04; H04W 4/33; H04W 4/38; H04W 4/024; H04W 4/80; G06F 3/167; A61G 2203/20; A61G 2203/16

(57) ABSTRACT

Systems and methods for navigating a residence include a first household appliance, a second household appliance, a beacon, and a portable user interface device. The systems and methods include determining a plurality of paths through the residence. The systems and methods also include receiving, from a user interface of the portable user interface device, an input comprising a selected destination and determining a current location of the portable user interface device based on a short-range radio signal after receiving the input. The systems and methods further include selecting one path from the plurality of paths through the residence. The one selected path starts at or near the determined current location of the portable user interface device and terminates at the selected destination. The systems and methods also include providing guidance to and along the one selected path.

### FIELD OF THE INVENTION

The present subject matter relates generally to systems and methods for navigating a residence, such as systems and methods which may provide assistance to persons with disabilities, visual impairments, etc., in navigating a residence.

### BACKGROUND OF THE INVENTION

Household appliances are utilized generally for a variety of tasks by a variety of users. For example, a household may include such appliances as laundry appliances, e.g., a washer and/or dryer, kitchen appliances, e.g., a refrigerator, a microwave, and/or a coffee maker, along with room air conditioners and other various appliances.

Some household appliances can also include features for connecting to and communicating wirelessly, such as over a wireless network. Such communication may provide connected features on the household appliances, e.g., where the household appliance communicates with a personal device, smart home systems, and/or a remote database such as a cloud server.

While some connected appliances are capable of communicating with other appliances and/or personal devices, such appliances typically only provide information about the appliances themselves or contents thereof, such as operational settings, e.g., temperature settings of a refrigerator appliance or air conditioning appliance, age of food items in the refrigerator appliance, cycle status of a dishwashing appliance or laundry appliance, or cooking status of an oven appliance, etc.

Accordingly, there exists a need for connected appliances which provide further benefits and functions, such as mapping of and navigation through the household or residence in which the household appliances are located.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of navigating a residence is provided. The method uses a first household appliance, a second household appliance, and a beacon. The method includes determining a plurality of paths through the residence. The method also includes receiving, from a user interface of a portable user interface device, an input comprising a selected destination and determining a current location of the portable user interface device based on a short-range radio signal after receiving the input. The method further includes selecting one path from the plurality of paths through the residence. The one selected path starts at or near the determined current location of the portable user interface device and terminates at the selected destination. The method also includes providing, via the portable user interface device, audible guidance to and along the one selected path.

In accordance with another embodiment of the present disclosure, a navigation system for navigating a residence is provided. The system includes a first household appliance, a second household appliance, a beacon, and a portable user interface device. The portable user interface device is configured for determining a plurality of paths through the residence. The portable user interface device is also configured for receiving, from a user interface of the portable user interface device, an input comprising a selected destination and determining a current location of the portable user interface device based on a short-range radio signal after receiving the input. The portable user interface device is further configured for selecting one path from the plurality of paths through the residence. The one selected path starts at or near the determined current location of the portable user interface device and terminates at the selected destination. The portable user interface device is also configured for providing audible guidance to and along the one selected path.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of exemplary laundry appliances in accordance with one or more exemplary embodiments of the present disclosure.

FIG. 2 provides a side cross-sectional view of one of the exemplary laundry appliances of FIG. 1.

FIG. 3 provides a perspective view of the other exemplary laundry appliance of FIG. 1 with portions of a cabinet of the laundry appliance removed to reveal certain components of the laundry appliance.

FIG. 4 provides a front view of an exemplary group of kitchen appliances in accordance with one or more additional exemplary embodiments of the present disclosure.

FIG. 5 provides a side schematic view of the group of kitchen appliances of FIG. 4.

FIG. 6 provides a perspective view of a refrigeration appliance in accordance with one or more additional exemplary embodiments of the present disclosure.

FIG. 7 provides a partial perspective view of an exemplary air conditioner appliance in accordance with additional embodiments of the present disclosure.

FIG. 8 provides a front view of an exemplary dishwashing appliance in accordance with one or more additional exemplary embodiments of the present disclosure.

FIG. 9 illustrates an exemplary floor plan of a residence in accordance with one or more additional exemplary embodiments of the present disclosure.

FIG. 10 illustrates the floor plan of FIG. 9 with points of interest therein.

FIG. 11 illustrates the floor plan of FIG. 9 with a plurality of paths through the residence.

FIG. 12 illustrates the floor plan of FIG. 11 with a selected one of the plurality of paths highlighted.

FIG. 13 provides a flowchart illustrating an example method of navigating a residence according to one or more example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

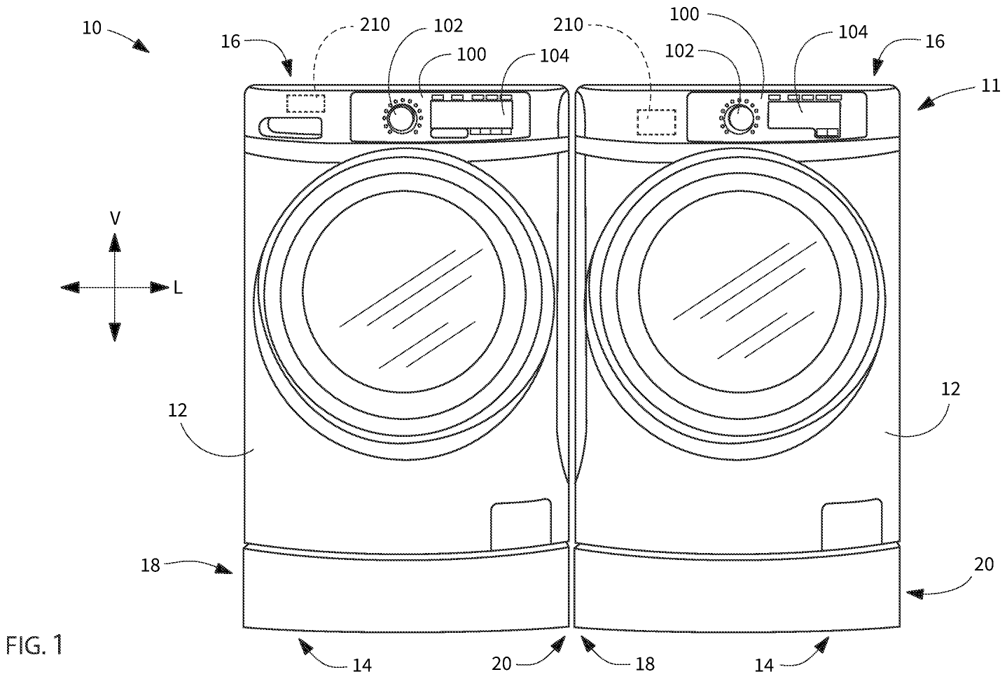

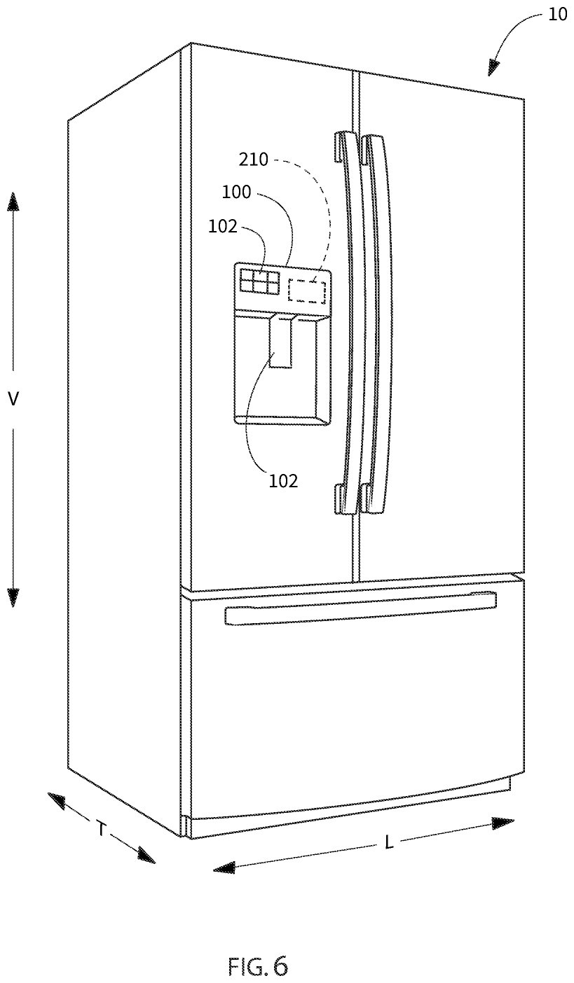

As may be seen in FIGS. 1 through 5, in accordance with one or more embodiments of the present subject matter, a group of appliances including at least a first appliance 10 and a second appliance 11 is provided. The illustrated groups of two appliances are provided by way of example only. Various embodiments of the present subject matter may also include three or more appliances. For example, FIGS. 6 through 8 illustrate additional appliances 10 which are depicted singly but each of which is to be understood as an exemplary member of a group of appliances. The exemplary appliances of FIGS. 6 through 8 may each be provided in various combinations with one or more of the other appliances of FIGS. 6 through 8 and/or either or both groups of appliances illustrated in FIGS. 1 through 5. Each appliance of the group or two or more appliances disclosed herein may be operable and configured to emit or broadcast a short-range radio signal for navigating through an interior space, as will be described in more detail below.

As generally seen throughout FIGS. 1 through 8, each appliance 10 and 11 includes a cabinet 12 which defines a vertical direction V and a lateral direction L that are mutually perpendicular. Each cabinet 12 extends between a top side 16 and a bottom side 14 along the vertical direction V. Each cabinet 12 also extends between a left side 18 and a right side 20, e.g., along the lateral direction L.

Each appliance 10 and 11 may include a user interface panel 100 and a user input device 102 which may be positioned on an exterior of the cabinet 12. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be the user input device 102.

Generally, each appliance 10 and 11 may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliances 10 and 11. Operation of the appliances 10 and 11 may each be regulated by the respective controller 210 that is operatively coupled to the corresponding user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance 10 or 11. Each controller 210 may include a memory and one or more microprocessors, CPUs or the like, such as general or special purpose microprocessors operable to execute programming instructions or micro-control code associated with operation of the appliance 10 or 11. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the respective appliance 10 or 11 by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, the group of appliances 10 and 11 may be or include a pair of laundry appliances. In the exemplary embodiment illustrated in FIG. 1, the first appliance may be a washing machine appliance 10 and the second appliance may be a clothes dryer 11. In other embodiments, the washing machine appliance may be the second appliance and the clothes dryer may be the first appliance. In embodiments such as illustrated in FIG. 1, the user input device 102 of each appliance 10 and 11 may be positioned on the user interface panel 100. The embodiment illustrated in FIG. 1 also includes a display 104 on the user interface panel 100 of each appliance 10 and 11.

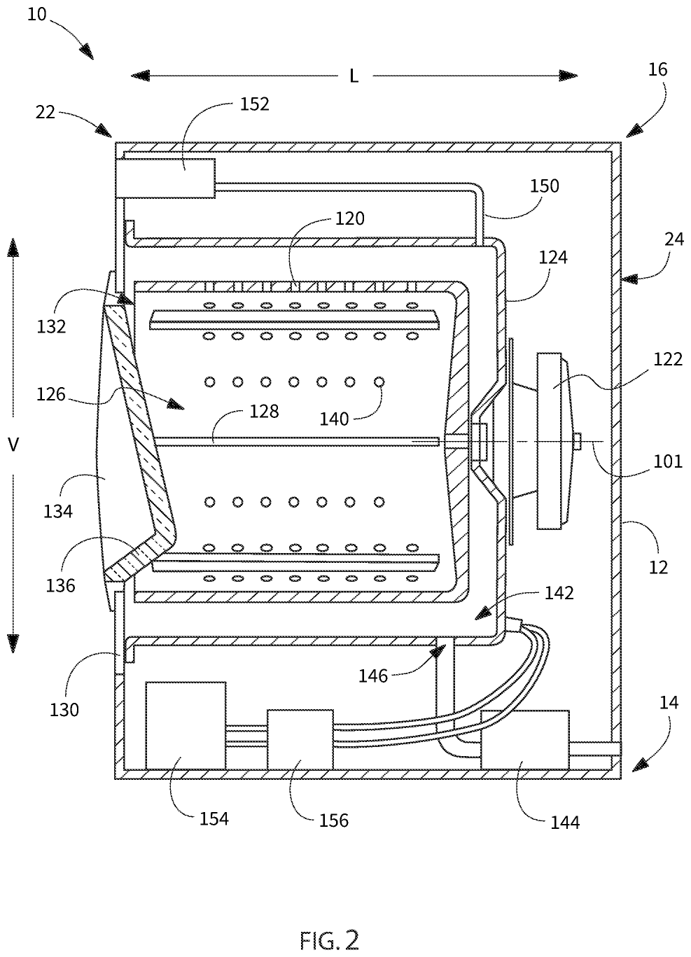

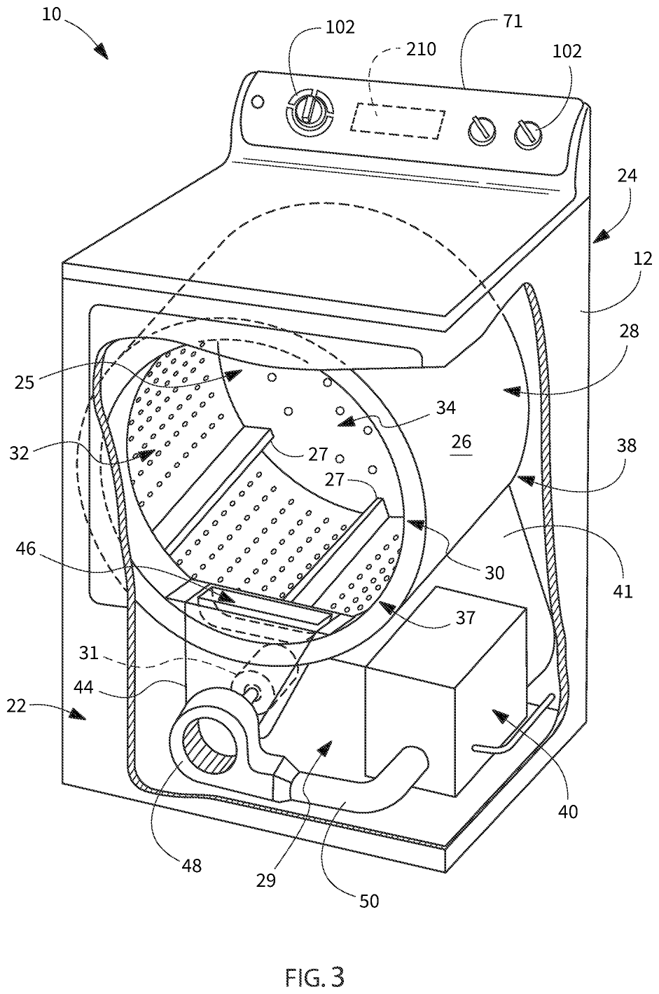

Additional exemplary details of the laundry appliances 10 and 11 are illustrated in FIGS. 2 and 3. For example, FIG. 2 provides a cross-sectional view of an exemplary washing machine appliance 10 which may, in various embodiments, be one appliance of a group of connected appliances. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1 with a portion of a cabinet or housing 12 of dryer appliance 11 removed in order to show certain components of dryer appliance 10. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 10.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 10 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on a cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 210 may be programmed to operate dryer appliance 10 by executing instructions stored in memory (e.g., non-transitory media). The controller 56 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller.

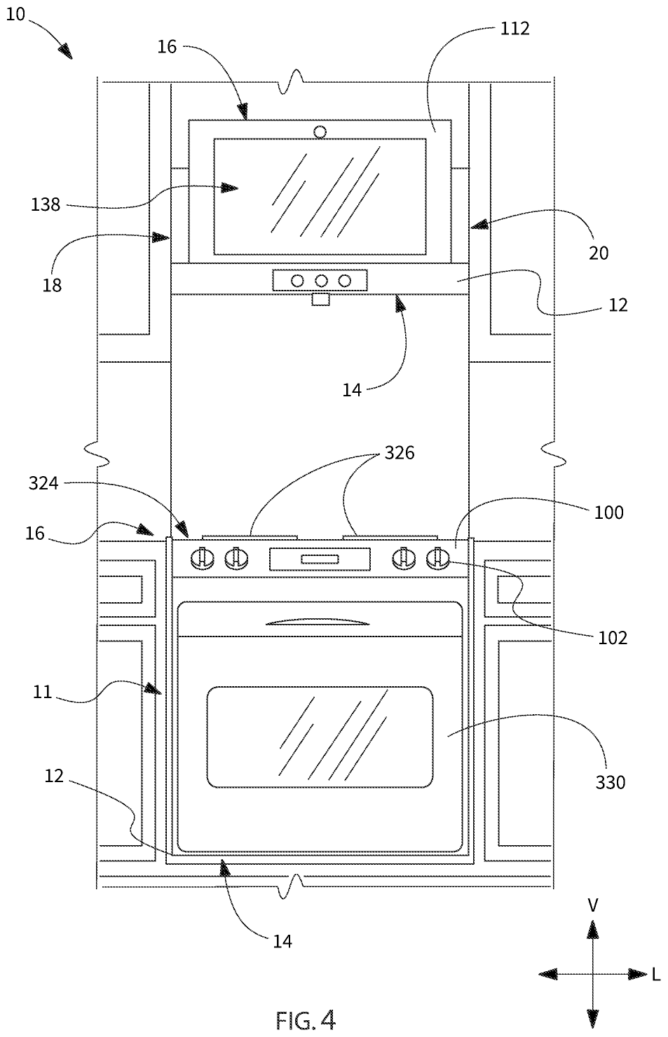

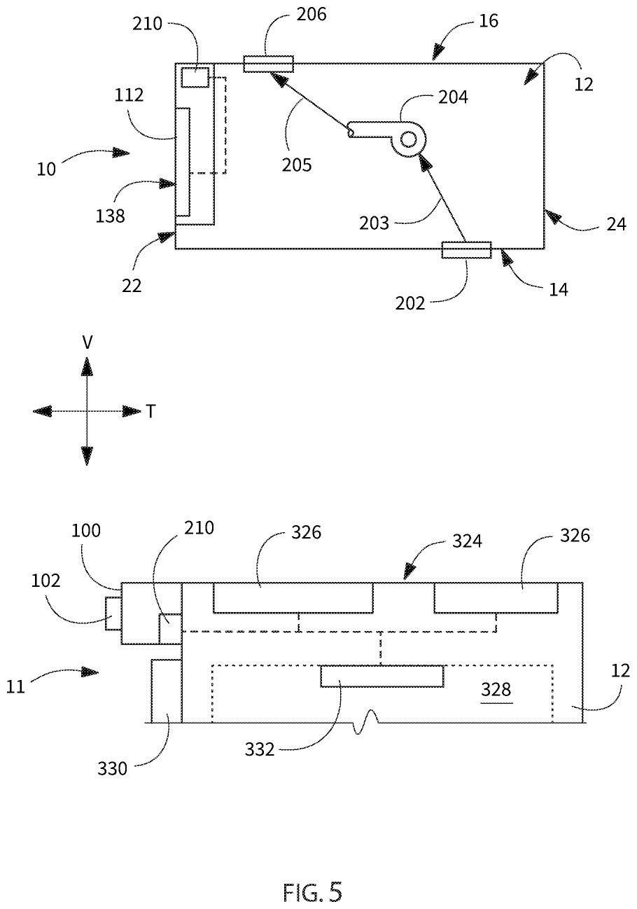

FIGS. 4 and 5 illustrate another example embodiment of a group of appliances where the first appliance 10 and the second appliance 11 are kitchen appliances. In the particular exemplary embodiment illustrated in FIGS. 4 and 5, the first appliance 10 is a user engagement system which includes an image monitor 112 that is generally positioned above a cooktop appliance 11, e.g., along the vertical direction V. Image monitor 112 may include a touchscreen capable of receiving a user input by detecting and responding to a touch on a surface of the image monitor 112. In additional embodiments, the first appliance 10 may be a microwave oven that is generally positioned above the cooktop appliance 11, e.g., along the vertical direction V. Moreover, in further embodiments, the microwave oven may be a third appliance of the group, and may be connected to one or both of the cooktop or oven appliance and the user engagement system.

As those of ordinary skill in the art will recognize, microwave oven appliances include a cabinet with cooking chamber defined therein and are configured to heat articles, e.g., food or beverages, within the cooking chamber using a heating assembly that emits electromagnetic radiation. The heating assembly of the microwave appliance may include various components which operate to produce the electromagnetic radiation, as is generally understood. For example, a microwave appliance may include a magnetron (such as, for example, a cavity magnetron), a high voltage transformer, a high voltage capacitor and a high voltage diode. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to the cooking chamber. The structure and intended function of microwave ovens are generally understood by those of ordinary skill in the art and, as such, are not specifically illustrated or described in further detail herein for the sake of brevity.

Referring again to FIGS. 4 and 5, as shown, cooktop appliance 11 includes a chassis or cabinet 12 that extends along the vertical direction V between a top side 16 and a bottom side 14. Cooktop appliance 11 can include a cooktop surface 324 having one or more heating elements 326 for use in, for example, heating or cooking operations. In one example embodiment, cooktop surface 324 is constructed with ceramic glass. In other embodiments, however, cooktop surface 324 may include any another suitable material, such as a metallic material (e.g., steel) or another suitable non-metallic material. Heating elements 326 may be various sizes and may employ any suitable method for heating or cooking an object, such as a cooking utensil (not shown), and its contents. In one embodiment, for example, heating element 326 uses a heat transfer method, such as electric coils or gas burners, to heat the cooking utensil. In another embodiment, however, heating element 326 uses an induction heating method to heat the cooking utensil directly. In various embodiments, the heating elements 326 may include one or more of a gas burner element, resistive heat element, radiant heat element, induction element, or another suitable heating element.

In some embodiments, the cabinet 12 of the cooktop appliance 11 may be insulated and may define a cooking chamber 328 selectively enclosed by a door 330. One or more heating elements 332 (e.g., top broiling elements or bottom baking elements) may be positioned within cabinet 12 of cooktop appliance 11 to heat cooking chamber 328. Heating elements 332 within cooking chamber 328 may be provided as any suitable element for cooking the contents of cooking chamber 328, such as an electric resistive heating element, a gas burner, a microwave element, a halogen element, etc. Thus, cooktop appliance 11 may be referred to as an oven range appliance. As will be understood by those skilled in the art, cooktop appliance 11 is provided by way of example only, and the present subject matter may be used in the context of any suitable cooking appliance, such as a double oven range appliance or a standalone cooktop (e.g., fitted integrally with a surface of a kitchen counter). Thus, the example embodiments illustrated and described are not intended to limit the present subject matter to any particular cooking chamber or heating element configuration, unless explicitly indicated as being limited.

As illustrated, a user interface panel 100 may be provided on cooktop appliance 11. Although shown at front portion of cooktop appliance 11, another suitable location or structure (e.g., a backsplash) for supporting user interface panel 100 may be provided in alternative embodiments. In some embodiments, user interface panel 100 includes input components or controls 102, such as one or more of a variety of electrical, mechanical, or electro-mechanical input devices. Controls 102 may include, for example, rotary dials, knobs, push buttons, and touch pads. A controller 210 is in communication with user interface panel 100 and controls 102 through which a user may select various operational features and modes and monitor progress of cooktop appliance 11. In additional or alternative embodiments, user interface panel 100 includes a display component, such as a digital or analog display in communication with a controller 210 and configured to provide operational feedback to a user. In certain embodiments, user interface panel 100 represents a general purpose I/O (“GPIO”) device or functional block.

As shown, controller 210 is communicatively coupled (i.e., in operative communication) with user interface panel 100 and its controls 102. Controller 210 may also be communicatively coupled with various operational components of cooktop appliance 300 as well, such as heating elements (e.g., 326, 332), sensors, and the like. Input/output (“I/O”) signals may be routed between controller 210 and the various operational components of cooktop appliance 11. Thus, controller 210 can selectively activate and operate these various components. Various components of cooktop appliance 11 are communicatively coupled with controller 210 via one or more communication lines such as, for example, conductive signal lines, shared communication busses, or wireless communications bands.

As shown in FIGS. 4 and 5, the cabinet 12 the first appliance 10 may be or include one or more casings (e.g., a hood casing) provided above cooktop appliance 11 along the vertical direction V. For example, a hood casing 12 may be positioned above cooktop appliance 11. Hood casing 12 includes a plurality of outer walls and generally extends along the vertical direction V between a top side 16 and a bottom side 14, along the lateral direction L between a right side 18 and a left side 20, e.g., “right” and “left” as used herein refer to from a perspective of a user standing in front of the appliance 10. As shown in FIG. 5, the hood casing 12 may also extend along the transverse direction T between a front end 22 and a back end 24. In some embodiments, hood casing 12 is spaced apart from cooktop surface 324 along the vertical direction V such that an open region is defined therebetween.

As shown in FIG. 5, in kitchen appliance embodiments, one of the group of appliances 10 and 11 may be or include a ventilation assembly within hood casing 12 which is configured to direct an airflow from the open region between the appliances 10 and 11 and through hood casing 12 of the upper appliance, e.g., which is indicated as first appliance 10 in the example illustrations of FIGS. 4 and 5, but which may instead be the second appliance 11, e.g., when the cooktop appliance is the first appliance 10. A range hood is provided by way of example only. Other configurations may be used within the spirit and scope of the present disclosure. For example, although a generally rectangular shape is illustrated, any suitable shape or style may be adapted to form the structure of hood casing 12. As another example, a microwave oven may be provided as well as or instead of the hood.

In some embodiments, an image monitor 112 may be provided above cooktop surface 324 (e.g., along the vertical direction V). For instance, image monitor 112 may be mounted to or supported on hood casing 12 of the first appliance 10 (e.g., directly above cooktop surface 324) proximal to the front side 22. Generally, image monitor 112 may be any suitable type of mechanism for visually presenting a digital (e.g., interactive) image. For example, image monitor 112 may be a liquid crystal display (LCD), a plasma display panel (PDP), a cathode ray tube (CRT) display, etc. Thus, image monitor 112 includes an imaging surface 138 (e.g., screen or display panel) at which the digital image is presented or displayed as an optically-viewable picture (e.g., static image or dynamic video) to a user. Optionally, a protective transparent panel (e.g., formed from a transparent glass, plastic, etc.) may be positioned across or over imaging surface 138. In some such embodiments, the protective transparent panel is mounted within or supported on hood casing 12 forward from imaging surface 138 along the transverse direction T.

As an example, image monitor 112 may present recipe information in the form of viewable text or images. As another example, image monitor 112 may present a remotely captured image, such as a live (e.g., real-time) dynamic video stream received from a separate user or device. As yet another example, image monitor 112 may present a graphical user interface (GUI) that allows a user to select or manipulate various operational features of the first appliance 10 or cooktop appliance 11. During use of such GUI embodiments, a user may engage, select, or adjust the image presented at image monitor 112 through any suitable input, such as gesture controls detected through a camera assembly, voice controls detected through one or more microphones, associated touch panels (e.g., capacitance or resistance touch panel), sensors overlaid across imaging surface 138, or any other suitable input.

As illustrated, the imaging surface 138 is directed toward the area forward from the cooktop appliance 11. During use, a user standing in front of cooktop appliance 11 may thus see the optically-viewable picture (e.g., recipe, dynamic video stream, graphical user interface, etc.) displayed at the imaging surface 138.

As mentioned, the first appliance 10 may be or include a ventilation assembly (and the ventilation assembly may also be the second appliance 11, e.g., when the cooktop appliance is the first appliance 10). In such embodiments, one or more air outlets 206 may be defined by hood casing 12 (e.g., through one or more external walls of hood casing 12). As shown for example in FIG. 5, air outlet 206 defined through hood casing 12 may be defined through hood casing 12 at the top side 16. The ventilation system may generally extend between one or more air inlets 202 defined in the bottom side 14 of the casing 12 and air outlet 206. For example, the bottom side 14 of the casing 12 of the first appliance 10 may face the cooktop surface 324 of the cooktop appliance 11. The ventilation system may also include an air handler 204 fixedly mounted within the casing 12 in fluid communication with the air inlet 202 to motivate an intake flow of air 203 through the inlet 202 to the air handler 204 and an exhaust flow of air 205 from the air handler 204 to the outlet 206.

As will be understood, air handler 204 may be provided as any suitable blower or fan (e.g., radial fan, tangential fan, etc.) positioned within hood casing 12 to actively rotate or motivate air, steam, or vapors 203 into and through air inlet 202. Optionally, one or more filters (not pictured) may be provided at inlet 202 to clean the air, steam, or vapors 203 as it enters hood casing 12 from the open region between the first and second appliances 10 and 11. For instance, a grease filter having a suitable coarse filter medium, such as a metallic mesh including aluminum or stainless steel, may be mounted across inlet 202. Additionally or alternatively, an odor filter having a suitable fine filter medium, such as a mesh or block including activated carbon, may be mounted across inlet 202. Optionally, the odor filter may be positioned above or downstream from the grease filter.

In another example embodiment, the appliance 10 may be a refrigeration appliance, such as is illustrated in FIG. 6. In some exemplary embodiments, the refrigeration appliance 10 of FIG. 6 may be one of a group of appliances, such as a first appliance, second appliance, third appliance, etc., of a group of appliances for a residential navigation system. Refrigerator appliance 10 is generally referred to as a bottom-mount refrigerator appliance. It should be understood that refrigeration appliance 10 is provided by way of example only. Thus, the present subject matter is not limited to refrigeration appliance 10 and any suitable refrigerator appliance may be utilized in the methods and systems of the present disclosure.

Still referring to FIG. 6, the refrigeration appliance may include a dispenser, e.g., coupled to the user interface panel 100, which may be configured to dispense cold water, hot water, and/or ice. In such embodiments, the user inputs 102 may include, for example, touch inputs (e.g., buttons, touch pad, or touch screen) on the user interface panel 100 and a mechanical actuator or switch for activating the dispenser. As illustrated, dispenser may include a dispenser recess defined on one of the refrigerator doors. The dispenser may include one or more outlets for dispensing ice, chilled liquid water, and/or heated liquid water. Dispenser may, for example, include a paddle 102 (which is an embodiment of a user input for activating the dispenser) mounted below the one or more outlets. As illustrated, the user inputs 102 on the user interface panel 100 may be manipulated, e.g., pressed, to control or select the mode of operation of dispenser, e.g., for selecting chilled liquid water, heated liquid water, crushed ice, and/or whole ice. User interface panel 100 may include a chilled water dispensing button (not labeled), an ice-dispensing button (not labeled) and a heated water dispensing button (not labeled) for selecting between chilled liquid water, ice, and heated liquid water, respectively. The particular structure and operation of the refrigerator and dispensing system are understood by those of skill in the art and, as such, are not described in further detail herein for the sake of brevity.

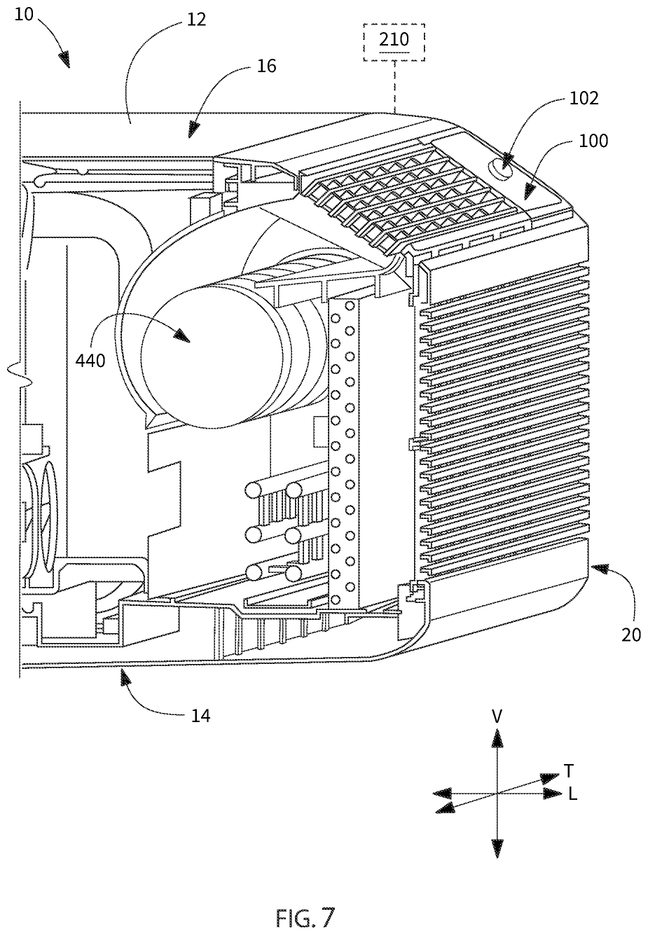

FIG. 7 illustrates another example embodiment of an appliance 10, wherein the appliance 10 is a room air conditioner. As illustrated, the exemplary air conditioner 10 includes cabinet 12, user interface panel 100 and user input device 102. In the illustrated example of FIG. 2, the user input device 102 is a control knob. The air conditioner 10 may also include a controller 210, and the controller 210 may be configured to activate the air conditioner 10, e.g., by turning on fan 440 to circulate air.

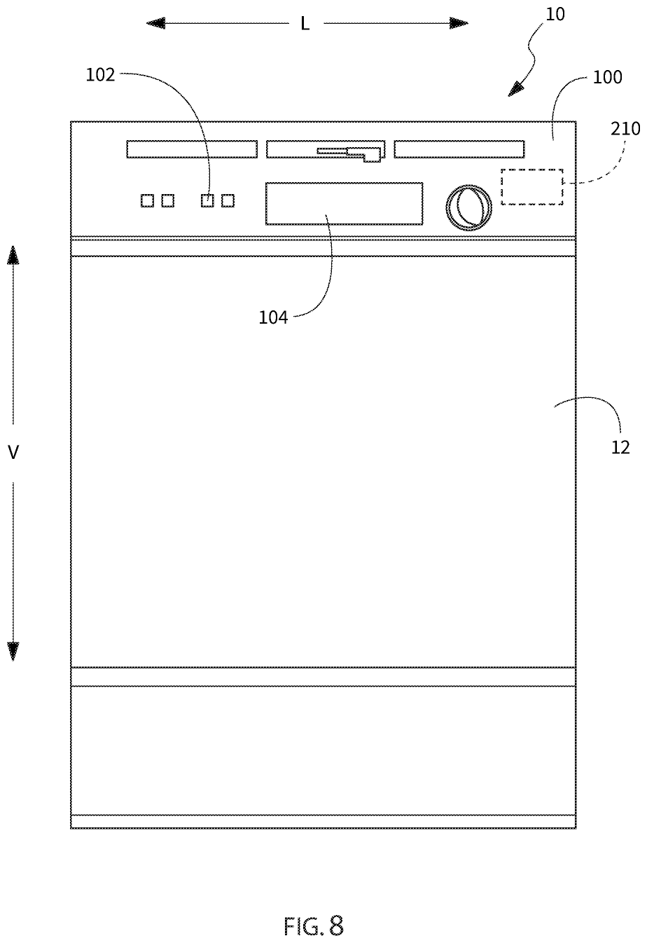

FIG. 8 provides a front view of a dishwashing appliance 10 according to yet another exemplary embodiment of the present subject matter. The dishwashing appliance includes a cabinet 12 with a user interface panel 100 thereon. In the illustrated example embodiment of FIG. 8, the user interface panel 100 includes multiple user input devices 102, e.g., a knob and a plurality of buttons, as well as a display 104. In various embodiments, any suitable combination of any one or more of the illustrated user input devices 102 and display 104 may be provided.

According to various embodiments of the present disclosure, the group of appliances 10 and 11 may take the form of any of the examples described above in various combinations of any two or more of the exemplary household appliances described above, or may be any other household appliance. Thus, it will be understood that the present subject matter is not limited to any particular household appliance.

It should be understood that “household appliances” and/or “appliances” are used herein to describe appliances typically used or intended for common domestic tasks, such as laundry appliances or kitchen appliances, e.g., as illustrated in FIGS. 1 and 2, or air conditioners, dishwashing appliances, water heaters, etc., and any other household appliance which performs similar functions in addition to network communication and data processing. Thus, devices such as a personal computer, router, and other similar devices whose primary functions are network communication and/or data processing are not considered household appliances as used herein.

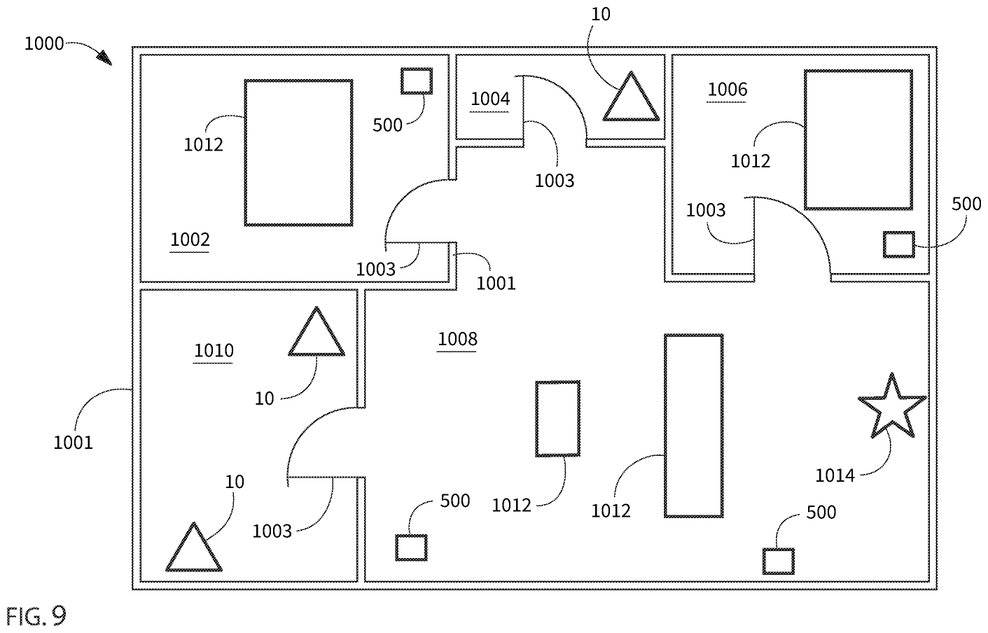

In various embodiments, the present disclosure may include a floor plan 1000 of a residence, examples of which are illustrated in FIGS. 9 through 12. As used herein, the term “residence” includes a domestic structure or dwelling place in which one or more people eat, sleep, and/or spend leisure time. For example, the residence may be a dormitory, condo unit, apartment unit, townhome, single-family home, or other similar places.

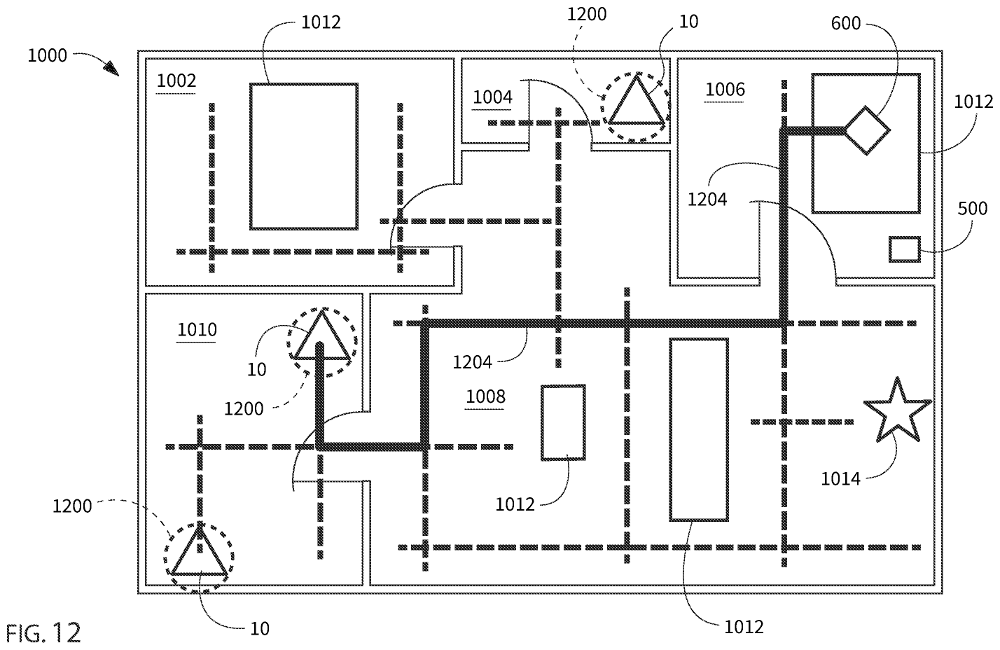

The floor plan of the residence may be input, e.g., uploaded, to an application (“app”) or other navigation software. For example, the app may be run on a portable user interface device 600 (FIG. 12). In various embodiments, the portable user interface device 600 may be, for example, a smartphone, tablet, wearable device such as a smart watch, and/or various other suitable devices which can be readily (easily and conveniently, e.g., based on the size and weight of the device) carried about by a person of average physical abilities. In some embodiments, the portable user interface device 600 may be a motorized wheelchair or powerchair which includes “smart” features such as a user interface, e.g., touchscreen, and networking capabilities such as WI-FI® connectivity and/or BLUETOOTH® connectivity, e.g., provided by one or more antenna and wireless communication module(s). In powerchair embodiments, the portable user interface device 600 carries the user rather than vice versa, nevertheless, the powerchair is considered “portable” at least in that it is readily movable throughout the residence by a single person of average (or less) physical ability. The portable user interface device 600 may include a memory for storing and retrieving programming instructions. For example, the portable user interface device 600 may be a smartphone operable to store and run applications, also known as “apps,” and may include a residential navigation software which is operable to and configured to perform one or more method steps of the residential navigation methods described herein, and such software may be provided as a smartphone app.

As illustrated for example in FIG. 9, the floor plan 1000 may include a general outline of the residence, such as an indication of the location and size of walls 1001 of the residence and doors 1003 therein. The floor plan 1000 may further include an indication or identification of rooms within the residence, e.g., that are separated and defined by the walls 1001. For instance, the exemplary floor plan illustrated in FIG. 9 includes a first room, e.g., first bedroom, 1002, a second room, e.g., laundry room, 1004, a third room, e.g., second bedroom, 1006, a fourth room, e.g., living room or drawing room, 1008, and a fifth room, e.g., kitchen, 1010. Obstacles, such as furniture, 1012 may be identified on the floor plan 1000. The floor plan 1000 may also include, in instances where the residence is a multi-story residence, a location of stairs 1014. The locations of one or more appliances 10 may also be called out on the floor plan 1000, as well as one or more beacons 500. As will be described in more detail below, the appliance 10 and the beacons 500 may be used to determine a current location of the portable user interface device 600. Accordingly, in order to provide an accurate determination of the location of the portable user interface device 600, at least one beacon 500 may be included in each room, and preferably three or more beacons 500 may be provided in each room.

In some embodiments, e.g., as illustrated in FIG. 9, the appliances 10 may include a plurality of kitchen appliances, e.g., in kitchen 1010, such as a refrigerator and a stove and/or microwave or other cooking appliance. Also, it is understood that such appliances are not necessarily or exclusively located in the kitchen 1010, for example, a microwave oven or mini fridge may be located in the drawing room 1008 or a refrigerator may be located in a basement or utility room, among other possible example alternative or additional locations. As another example, an appliance 10 is located in the laundry room 1004 in FIG. 9, and such appliance 10 may be a laundry appliance, such as a washing machine, a dryer, a stacked washer and dryer, or a combination washer-dryer appliance, among other examples.

In some embodiments, the basic elements of the floor plan 1000 may be provided to the residential navigation app as an upload, such as the walls 1001, doors 1003, and stairs 1014. In such embodiments, the identifications of the various rooms (if room identifiers are included) may be manually entered. Also, the locations of the obstacles 1012, appliances 10, and beacons 500 may be manually entered. For example, the location of each appliance 10 on the floor plan 1000 may be manually entered when the appliance 10 is commissioned and connected to, e.g., the other appliances 10 and/or a home network.

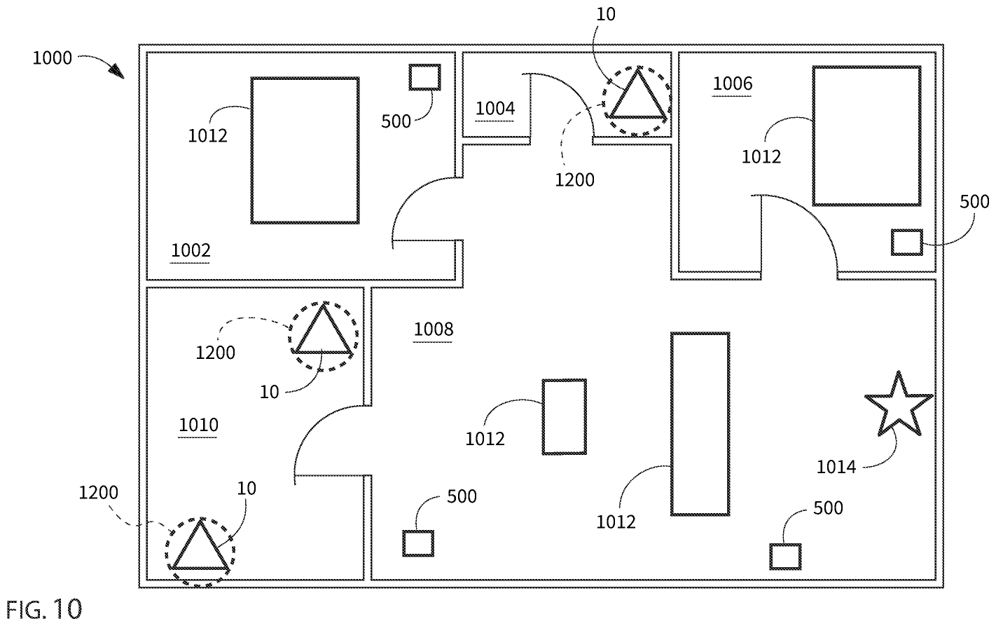

Turning now to FIG. 10, in some embodiments, a plurality of points of interest, e.g., potential destinations, 1200 may be identified on the floor plan 1000. For example, the points of interest 1200 may be manually entered or selected by a user after the locations of all the objects, e.g., the rooms, appliances, etc., are entered on the floor plan 1000 and the points of interest 1200 may be selected ones of the objects on the floor plan 1000. In the example embodiment illustrated in FIG. 10, each appliance 10 is identified as a point of interest 1200.

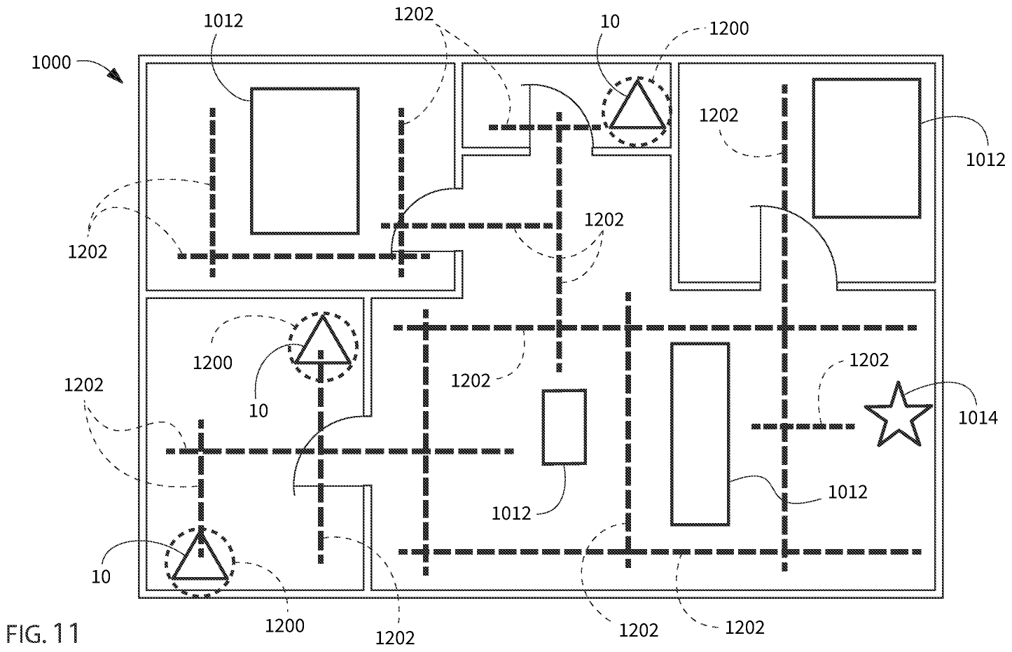

FIG. 11 illustrates a plurality of paths 1202 through the residence on the floor plan 1000. In some embodiments, the plurality of paths 1202 may be determined by software, e.g., a residential navigation app running on the portable user interface device 600, based on the uploaded and/or input floor plan 1000 data. For example, as illustrated in FIG. 11, the paths 1202 may extend into and out of each room of the plurality of rooms, e.g., through the doors 1003, around each obstacle 1012, and at least one path of the plurality of paths 1202 may terminate at each point of interest 1200, e.g., at each appliance 10, and at the stairs 1014, when stairs 1014 are present.

FIG. 12 illustrates a selected one 1204 of the plurality of paths 1202. For example, the selected path 1204 may comprise a plurality of path segments which are serially and sequentially connected to lead from an origin to a destination, where each segment is one of the paths 1202 or a portion of one of the paths 1202. The origin of the selected path 1204 may be defined or determined based on a current location of the portable user interface device 600. The termination or end of the selected path 1204 may be defined based on a user input, e.g., which is received from a user interface (such as a touchscreen or voice command) of the portable user interface device 600. The user input may include a selected destination. As may be seen by way of example in FIG. 12, the selected path 1204 begins at the current location of the portable user interface device 600, which is a proxy for the user's location, and ends at one of the appliance 10 in the kitchen 1010, e.g., at the refrigerator. Thus, the selected path 1204 may be identified, constructed, compiled, or otherwise selected from the plurality of paths 1202 in response to a user input, such as, in the exemplary embodiment illustrated in FIG. 12, an input including a selection or indication of the refrigerator appliance 10 as the desired destination.

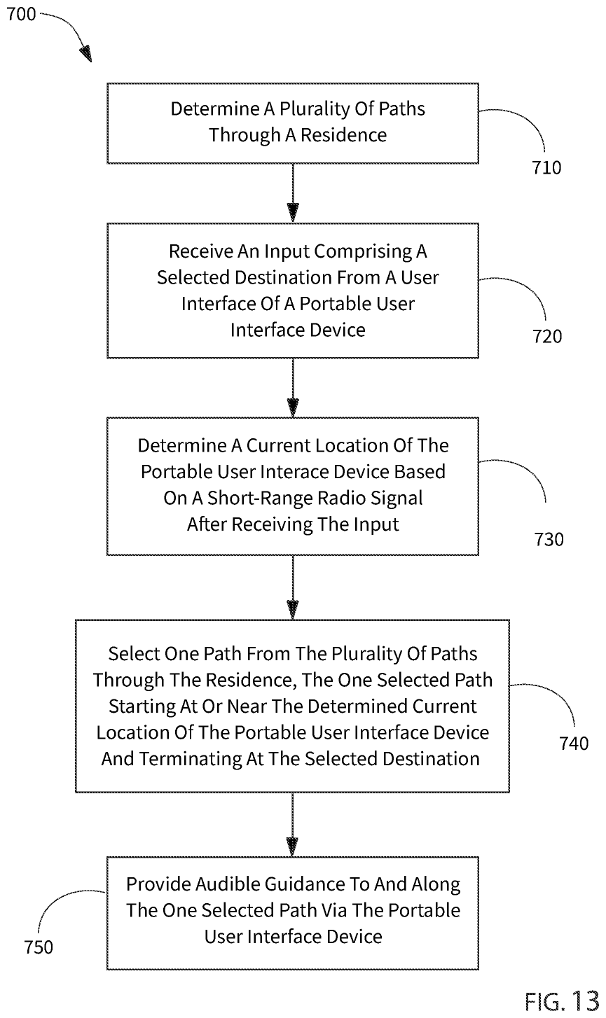

Exemplary methods according to the present subject matter include methods of navigating a residence, such as the method 700 illustrated in FIG. 13. As illustrated in FIG. 13, in some embodiments, an example method 700 may include a step 710 of determining a plurality of paths through the residence. For example, the plurality of paths may be or include the paths 1202 illustrated in FIG. 11 and described above. Thus, in some exemplary embodiments, the step 710 of determining the plurality of paths 1202 may include analyzing a floor plan, such as floor plan 1000 described above, to determine all possible routes between rooms and points of interest, e.g., by travelling through doors 1003 and avoiding obstacles 1012.

In some embodiments, the method 700 may include a step 720 of receiving an input comprising a selected destination. The input may be received, e.g., on a user interface of the portable user interface device 600, such as a touchscreen which receives a tactile input or a microphone which receives a voice command.

After receiving the input, e.g., in response to the input including the selected destination, the method 700 may include a step 730 of determining a current location of the portable user interface device 600 based on a short-range radio signal. For example, the short-range radio signal may be broadcast by the group of appliances in the residence and/or by the beacons 500. Accordingly, the current location of the portable user interface device 600 may be determined by triangulation from the plurality of short-range radio broadcasts, e.g., based on known locations of the appliances 10 and the beacons 500 in the floor plan 1000 and the relative strengths of the short-range radio broadcasts from each. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). The short-range radio signal may be, for example, a BLUETOOTH® Low Energy, e.g., BLUETOOTH® Version 4.0 or higher, signal. For example, BLUETOOTH® Low Energy may advantageously minimize the power consumed by the exemplary methods and systems described herein due to the low power networking protocol of BLUETOOTH® Low Energy. As another example, BLUETOOTH® Low Energy may advantageously provide improved accuracy in determining a distance between the portable user interface device 600 and the source of each broadcast, e.g., each appliance 10 and/or beacon 500. For instance, BLUETOOTH® Low Energy is more accurate than GPS and may provide fine-grained location and distance from an appliance 10 and/or beacon 500.

After, e.g., based on and in response to, receiving the selected destination and determining the current location of the portable user interface device 600, the method 700 may then include a step 740 of selecting one path from the plurality of paths through the residence. As described above, the one selected path 1204 may include a single path of the plurality of paths 1202 and/or a plurality of path segments where each segment is one path of the plurality of paths 1202 or a portion of one path of the plurality of paths 1202. The one selected path starts at or near the determined current location of the portable user interface device 600 and terminates at the selected destination. As used herein, “near” includes the one selected path 1204 starting in the same room as the current location of the portable user interface device 600, such as at the closest point (along a straight line) on one of the plurality of paths 1202 to the current location of the portable user interface device 600.

The method 700 may further include a step 750 of providing audible guidance to and along the one selected path via the portable user interface device 600. For example, the audible guidance may include voice commands, such as step-by-step directions along the one selected path 1204. Additionally, the method 700 may also include other forms of guidance, such as haptic feedback or audible alerts (e.g., beeps), e.g., when the portable user interface device 600 approaches within a predefined proximity limit of a wall 1001, obstacle 1012, or one of the appliances 10, such as the destination appliance 10. In some embodiments, the one selected path 1204 may also be illuminated or highlighted on the floor plan 1000, such as on a display of the portable user interface device 600.

In order to provide guidance along the one selected path, the location information of the portable user interface device 600 may be periodically and/or continuously updated until the portable user interface device 600 reaches the selected destination. For example, in some embodiments, the method 700 may also include receiving a plurality of short-range radio broadcasts from the appliances 10 and the beacons 500, e.g., over a span of time, while the portable user interface device 600 (and the user with it as the user is generally carrying or wearing, and in some embodiments, riding in or on, the portable user interface device) travels along the one selected path 1204 and until arriving at the sleeted destination. Thus, in some embodiments, the method 700 may include tracking the location of the portable user interface device 600 in real time or near real time, e.g., with a delay of one or two seconds or less, such as a delay of about 0.5 seconds or less. Such embodiments may further include comparing the tracked location of the portable user interface device to the one selected path 1204, such as determining a distance between the tracked location and the nearest point on the selected path. Also, additional guidance may be provided when the tracked current location of the portable user interface device 600 exceeds a predefined distance from the one selected path. Thus, embodiments of the method 700 may include, e.g., during the step 750, providing audible guidance along the one selected path while tracking and updating the current location of the portable user interface device based on the plurality of short-range radio broadcasts, and comparing the tracked location of the portable user interface device to the one selected path.

In some embodiments, the method 700 may also include providing a user notification on a user interface of the household appliance 10 which is the selected destination when the determined current location of the portable user interface is at the termination of the one selected path, e.g., when the portable user interface device 600 has reached the selected destination. For example, the method 700 may include turning on a light of the one household appliance that is the selected destination when the determined current location of the portable user interface is at the termination of the one selected path.

In some embodiments, the method 700 may also include milestones or waypoints, such as announcing or identifying a halfway point along the selected path 1204, a quarter point and/or a three-quarters point, etc. For example, in some embodiments, the method 700 may include providing a user notification on the portable user interface device 600 when the determined current location of the portable user interface device 600 is at a distance from the selected destination along the one selected path that is less than or equal to one half of a total length of the one selected path, such as less than or equal to one quarter of the total length of the one selected path, such as less than or equal to one tenth of the total length of the one selected path.

In various embodiments, the destination appliance 10 may be responsive to the user (as inferred from the location of the portable user interface device 600) approaching and/or arriving at the destination appliance 10. For example, the appliance 10 may be configured to do noisy tasks when the user is not in the proximity of the appliance 10, e.g., when the user is not in the same room as the appliance 10. In exemplary embodiments where the appliance 10 is a refrigerator appliance, such noisy tasks may include operating an icemaker therein, such as dispensing ice pieces, e.g., ice cubes, into a storage bin from the icemaker. In exemplary embodiments where the appliance 10 is a dishwashing appliance or laundry appliance, the noisy task which is performed when the portable user interface device 600 is not proximate to the appliance 10 may be a drain cycle or drain operation. Also in laundry appliance embodiments, the noisy task may also or instead include a spin cycle.

In additional exemplary embodiments where the destination appliance 10 is responsive to the user, the appliance 10 may be configured to provide a notification on a user interface of the appliance 10 itself when the user is nearby (e.g., based on the location of the portable user interface device 600 being, e.g., at least within the same room as the appliance 10, or within a predetermined distance such as less than about ten feet from the destination appliance), and may provide the notification via the portable user interface device 600 when the user is not proximate to the appliance, e.g., is in a different room than the appliance or is at least ten feet away from the appliance. For example, when a task is finished, such as preheating an oven appliance or when a wash cycle of a laundry appliance is complete, etc., the appliance may first check to see if the user is proximate to the appliance, e.g., based on the relative strength of short-range radio signals received by the portable user interface device 600 from one or more appliance(s) 10 and/or beacon(s) 500 as described above, before transmitting the notification. Accordingly, when the user is proximate to the appliance as described, the notification may be provided by the appliance directly (e.g., the appliance may beep and/or display a message indicating the status of the task on a display of the appliance) and when the user is not proximate to the appliance as described, the appliance may transmit a signal to the portable user interface device, and the portable user interface device may display a notification and/or provide an audible notification of the task status on the portable user interface device.

In additional exemplary embodiments where the destination appliance 10 is responsive to the user, the appliance 10 may be configured to activate a light on or in the appliance when the user arrives at the appliance or within a predetermined distance of the appliance, such as within about ten feet or less, such as within about seven feet or less, such as within about three feet or less. For example, in some embodiments, the light may be a light inside the drum of a laundry appliance, a light inside a cooking chamber of a cooking appliance (e.g., stove or microwave, etc.), or may be a backlight of a display of the appliance, such as in embodiments where the destination appliance is a refrigerator appliance. Further, in some embodiments, the appliance and/or a user interface thereof such as a touchscreen or display may wake from a sleep mode or enter a standby mode in response to the proximity of the user.

In further exemplary embodiments where the destination appliance 10 is responsive to the user, the appliance 10 may be configured to deactivate the appliance or selected components thereof when the user in not detected in proximity after a predetermined period of time. The predetermined period of time may be a few hours or may be several days. For example, a water heater appliance may be operable to and configured to automatically switch itself off and/or send a notification to a portable user interface device such as a phone, after a period of days in order to conserve power, for example, if the user has gone on vacation and forgot to switch off the water heater. As another example, an air conditioning appliance may be operable to and configured to automatically switch itself off and/or send a notification to a portable user interface device such as a phone, after a period of a few hours, such as about one hour to about four hours, such as about one and a half hours or about two hours.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of navigating a residence using a first household appliance, a second household appliance, and a beacon, the method comprising:
determining a plurality of paths through the residence;
receiving, from a user interface of a portable user interface device, an input comprising a selected destination;
determining a current location of the portable user interface device based on a short-range radio signal after receiving the input;
selecting one path from the plurality of paths through the residence, the one selected path starting at or near the determined current location of the portable user interface device and terminating at the selected destination; and
providing, via the portable user interface device, audible guidance to and along the one selected path.

2. The method of claim 1, further comprising receiving a plurality of short-range radio broadcasts from the first household appliance, the second household appliance, and the beacon while providing audible guidance along the one selected path, tracking and updating the current location of the portable user interface device based on the plurality of short-range radio broadcasts, and comparing the tracked and updated location of the portable user interface device to the one selected path.

3. The method of claim 1, wherein the current location of the portable user interface is determined by receiving a first short-range radio signal from the first household appliance, a second short-range radio signal from the second household appliance, and a third short-range radio signal from the beacon, comparing strength of the first short-range radio signal, the second short-range radio signal, and the third short-range radio signal, and determining the current location of the portable user interface device based on the strengths of the first short-range radio signal, the second short-range radio signal, and the third short-range radio signal.

4. The method of claim 1, wherein the selected destination is one of the first household appliance and the second household appliance.

5. The method of claim 4, further comprising providing a user notification on a user interface of the one of the first household appliance and the second household appliance when the determined current location of the portable user interface is at the termination of the one selected path.

6. The method of claim 4, further comprising providing a user notification on the portable user interface device when the determined current location of the portable user interface is at a distance along the one selected path that is less than or equal to one half of a total length of the one selected path.

7. The method of claim 4, further comprising turning on a light of the one of the first household appliance and the second household appliance when the determined current location of the portable user interface is at the termination of the one selected path.

8. The method of claim 1 wherein the short-range radio signal is a Bluetooth Low Energy signal.

9. The method of claim 1, wherein the portable user interface device is a powerchair.

10. The method of claim 1, wherein the portable user interface device is a wearable device.

11. A navigation system for navigating a residence, comprising:
a first household appliance;
a second household appliance;
a beacon; and
a portable user interface device, the portable user interface device configured for:
determining a plurality of paths through the residence;
receiving, from a user interface of the portable user interface device, an input comprising a selected destination;
determining a current location of the portable user interface device based on a short-range radio signal after receiving the input;
selecting one path from the plurality of paths through the residence, the one selected path starting at or near the determined current location of the portable user interface device and terminating at the selected destination; and
providing audible guidance to and along the one selected path.

12. The navigation system of claim 11, wherein the portable user interface device is further configured for receiving a plurality of short-range radio broadcasts from the first household appliance, the second household appliance, and the beacon while providing audible guidance along the one selected path, tracking and updating the current location of the portable user interface device based on the plurality of short-range radio broadcasts, and comparing the tracked and updated location of the portable user interface device to the one selected path.

13. The navigation system of claim 11, wherein the portable user interface device is configured for determining the current location of the portable user interface device by receiving a first short-range radio signal from the first household appliance, a second short-range radio signal from the second household appliance, and a third short-range radio signal from the beacon, comparing strength of the first short-range radio signal, the second short-range radio signal, and the third short-range radio signal, and determining the current location of the portable user interface device based on the strengths of the first short-range radio signal, the second short-range radio signal, and the third short-range radio signal.

14. The navigation system of claim 11, wherein the selected destination is one of the first household appliance and the second household appliance.

15. The navigation system of claim 14, wherein the one of the first household appliance and the second household appliance is configured for providing a user notification on a user interface of the one of the first household appliance and the second household appliance when the determined current location of the portable user interface is at the termination of the one selected path.

16. The navigation system of claim 14, wherein the portable user interface device is further configured for providing a user notification on the portable user interface device when the determined current location of the portable user interface is at a distance along the one selected path that is less than or equal to one half of a total length of the one selected path.

17. The navigation system of claim 14, wherein the one of the first household appliance and the second household appliance is configured for turning on a light of the one of the first household appliance and the second household appliance when the determined current location of the portable user interface is at the termination of the one selected path.

18. The navigation system of claim 11, wherein the short-range radio signal is a Bluetooth Low Energy signal.

19. The navigation system of claim 11, wherein the portable user interface device is a powerchair.

20. The navigation system of claim 11, wherein the portable user interface device is a wearable device.
